(19) United States
(12) Patent Application Publication
(10) Pub. No.: US 2013/0333020 A1
(43) Pub. Date: Dec. 12, 2013

(54) Method and Apparatus for Unlocking an Electronic Device that Allows for Profile Selection

(71) Applicant: Rupalee A. Deshpande, San Diego, CA (US)

(72) Inventor: Rupalee A. Deshpande, San Diego, CA (US)

(73) Assignee: Motorola Mobility, Inc., Libertyville, IL (US)

(21) Appl. No.: 13/491,745

(22) Filed: Jun. 8, 2012

(51) Int. Cl. G06F 21/00

(52) U.S. Cl. 726/16

(57) ABSTRACT

A method and apparatus for unlocking an electronic device that allows for profile selection includes the electronic device storing a plurality of profiles, each of which is associated with a different unlocking pattern, and receiving a first pattern input generated from motion upon a user interface of the electronic device. The method further includes the electronic device determining that the first pattern input matches an unlocking pattern associated with a first profile of the plurality of profiles and performing an unlocking procedure.

### FIELD OF THE DISCLOSURE

The present disclosure relates generally to the operation of electronic devices and more particularly to methods and apparatus for unlocking electronic devices that allow for profile selection.

### BACKGROUND

The invention of the transistor in late 1947 followed by an appreciation for its commercial potential by the mid 1950s sparked an electronic revolution that is still ongoing today. As manufacturers advance electronic technologies to compete for their respective market shares, consumers are presented with an ever-increasing choice of sophisticated new devices that continue to evolve. Cell phones, for example, have become “smart,” providing their owners with more than just a means of making and receiving calls without being tethered to a landline. A contemporary cell phone, for example, can be used to make group calls, play video games, navigate via GPS, send text messages, surf the Internet, calculate tips, listen to music, schedule meetings, take pictures, stream video, and even shop for applications, all from a single handheld device.

Modern electronic devices are being transformed into indispensable tools that affect the way people conduct their daily lives. As these devices continue to gain in popularity and complexity, they are also being programmed with more personal information for one or more users (e.g., a primary user, such as the device owner, and one or more secondary users) to take full advantage of their extensive capabilities. This presents potential drawbacks that need to be addressed. A device owner, for instance, may not want certain information to be accessible to secondary users. Further, different secondary users might require different levels of screening. Moreover, access for a family member using a cell phone need not be limited to the same extent as for a stranger borrowing the phone to make a call.

On the other side of the spectrum, having full access to electronic devices can in some instances make those devices more difficult to navigate and use, even for their owners. Trying to locate a social contact from among a large number of business contacts on a cell phone that is used for both purposes serves as one example. Another example is the unnecessary utilization of memory and processing resources of a cell phone by loading both work- and non-work-related applications concurrently.

Accordingly, there is a need for a method and apparatus for unlocking an electronic device that allows for profile selection.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 illustrates an electronic device having a touch screen user interface implementing embodiments of the present teachings.

FIG. 2 is a logical flowchart illustrating a method for unlocking an electronic device that allows for profile selection in accordance with some embodiments of the present teachings.

FIG. 3 is a schematic diagram illustrating different tracing patterns on a locked display in accordance with some embodiments of the present teachings.

FIG. 4 is a schematic diagram illustrating different tracing patterns on a locked display in accordance with some embodiments of the present teachings.

FIG. 5 is a schematic diagram illustrating different tracing patterns on a locked display in accordance with some embodiments of the present teachings.

FIG. 6 is a schematic diagram illustrating unlocking and authentication procedures in accordance with some embodiments of the present teachings.

FIG. 7 is a schematic diagram of profiles stored on an electronic device in accordance with some embodiments of the present teachings.

FIG. 8 illustrates an electronic device having a mechanical user interface implementing embodiments of the present teachings.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention. In addition, the description and drawings do not necessarily require the order illustrated. It will be further appreciated that certain actions and/or steps may be described or depicted in a particular order of occurrence while those skilled in the art will understand that such specificity with respect to sequence is not actually required.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Generally speaking, pursuant to the various embodiments, the present disclosure provides a method and apparatus for unlocking an electronic device that allows for profile selection. This allows a user the convenience of making a quick switch between profiles, wherein a particular profile is selected based on the way or manner in which the device is unlocked. In accordance with the teachings herein, a method for unlocking an electronic device that allows for profile selection comprises storing a plurality of profiles, each associated with a different unlocking pattern, and receiving a pattern input generated from motion upon a user interface of the electronic device. The method additionally comprises determining that the pattern input matches an unlocking pattern associated with a first profile of the plurality of profiles, and performing an unlocking procedure.

Further in accordance with the teachings herein is an electronic device comprising a user interface adapted to receive tactile input and a memory adapted to store a plurality of profiles each associated with a different pattern of movement used to provide access to operate the electronic device. The electronic device also comprises a processing element adapted to process the tactile input, wherein the processing comprises: detecting a first pattern of movement from the tactile input, determining that the first pattern of movement is associated with a first profile of the plurality of profiles, and allowing access to operate the device and responsively loading the first profile.

Also in accordance with the teachings herein, is a non-transient computer-readable storage element having computer-readable code stored thereon for programming a computer to perform a method for unlocking an electronic device that allows for profile selection. The method comprises receiving user input for storing a plurality of profiles, each associated with a different unlocking pattern, wherein each stored profile and associated stored unlocking pattern corresponds to at least one different non-alphanumeric pattern of movement, and receiving a pattern input generated from non-alphanumeric motion upon a user interface of the electronic device. The method additionally comprises determining that the pattern input matches an unlocking pattern associated with a first profile of the plurality of profiles, and performing an unlocking procedure.

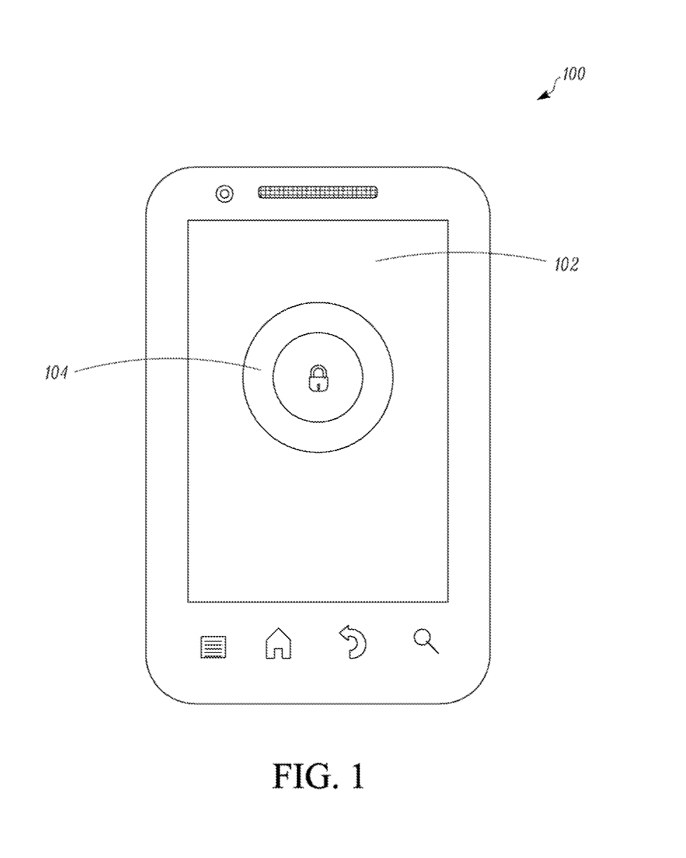

Referring now to the drawings, and in particular FIG. 1, an electronic device (also referred to herein simply as a “device”) implementing embodiments in accordance with the present teachings is shown and indicated generally at 100. Specifically, device 100 represents a cellular telephone comprising a user interface 102 adapted to receive tactile input, a memory (not shown) adapted to store a plurality of profiles, and a processing element or device (not shown) adapted to process the tactile input. Only a limited number of elements are shown for ease of illustration, but additional such elements may be included in device 100. Moreover, other components needed for a commercial embodiment of device 100 are omitted for clarity in describing the enclosed embodiments.

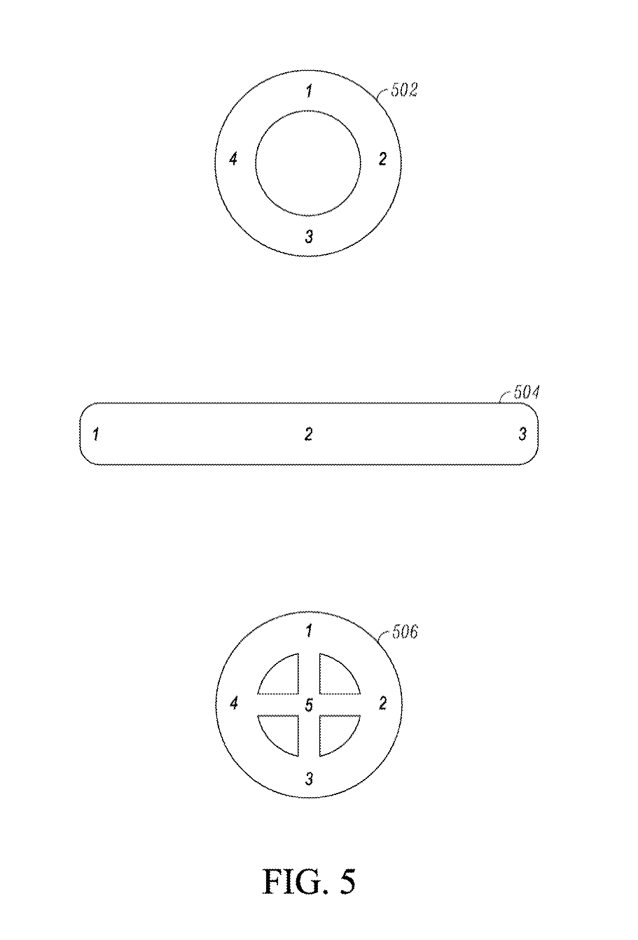

While a cellular telephone is shown at 100, no such restriction is intended or implied as to the type of device to which these teachings may be applied. Other suitable devices include: tablets, global positioning system (GPS) receivers, television (TV) remote controls, personal digital assistants (PDAs), audio- and video-file players (e.g., MP3 players and iPODs), digital cameras, and e-book readers (e.g., Kindles and Nooks), for example. For purposes of these teachings, an electronic device can be any device that comprises at least one user interface, is capable of storing a plurality of profiles (also referred to herein as “user profiles”), and that also has the ability to process tactile input received through the user interface to select one of the plurality of stored profiles. A “profile” is defined as a set of one or more preferences specified by a user of a device. Examples of user profiles are given below by reference to FIG. 5.

Individual profiles stored on a device are selectively loaded for use in response to tactile input which is entered by a user and received by the device via its user interface. Tactile input is input that results from physical contact with the user interface (i.e., touch). Contact can either be made directly, such as touching a user interface with a finger, or indirectly by using an implement, such as a stylus, to act as an intermediary. The user interface itself comprises any element capable of being immediately manipulated to pass information to the device. A non-exhaustive list of user interfaces capable of detecting tactile input includes: touch screens, knobs, dials, buttons, switches, joy sticks, and levers, for example. Conversely, a camera programmed for facial recognition and an accelerometer that responds to being shaken are examples of user interfaces that are not capable of receiving tactile input.

In general, for purposes of these teachings, electronic devices are adapted with functionality in accordance with embodiments of the present disclosure as described in detail below with respect to the remaining figures. “Adapted,” “configured” or “capable of” as used herein means that the indicated elements are implemented using one or more (although not shown) memory devices, interfaces (e.g., user interfaces and network interfaces) and/or processing elements that are operatively coupled. The memory devices, interfaces and/or processing elements, when programmed, form the means for these device elements to implement their desired functionality.

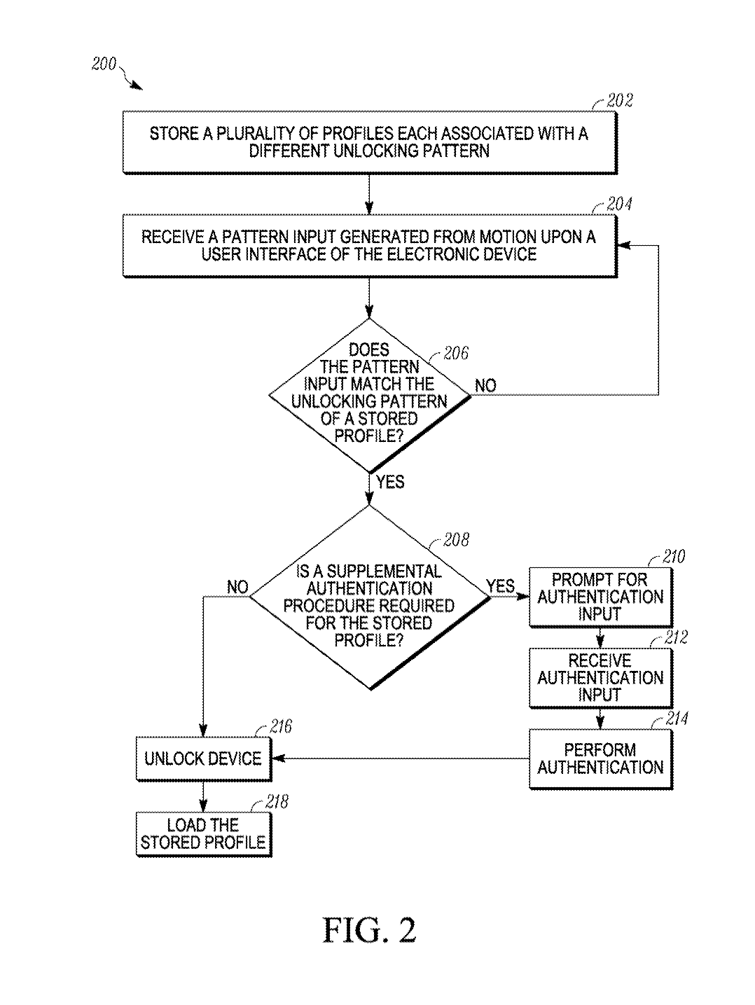

The processing element utilized by the electronic device at 100 may be partially implemented in hardware and, thereby, programmed with software or firmware logic or code for performing functionality described by reference to FIGS. 2-8; and/or the processing element may be completely implemented in hardware, for example, as a state machine or ASIC (application specific integrated circuit). The memory implemented by the electronic device can include short-term and/or long-term storage of various information needed for the proper functioning of the device. The memory may further store software or firmware for programming the processing element with the logic or code needed to perform its functionality.

We turn now to a more detailed description of the functionality of an electronic device, such as the device shown at 100, in accordance with the teachings herein and by reference to the remaining figures. FIG. 2 shows a logical flow diagram 200 illustrating a method for unlocking an electronic device that allows for profile selection. At 202, the device stores a plurality of profiles, each of which is associated with a different unlocking pattern. Multiple user profiles may be created for both a primary user (typically the owner of the device) and secondary users, as indicated below by reference to FIG. 5. Each of these profiles is stored on the device and associated with a different unlocking pattern and a different pattern of movement, since each unlocking pattern is derived from a particular and unique pattern of movement by a user upon the user interface of the device.

More particularly, non-alphanumeric motion (a pattern of movement) by a user upon a user interface of an electronic device generates a pattern input that is registered (i.e., received) by the device. Accordingly, a pattern input is defined herein as a user input generated by or as a result of at least one non-alphanumeric pattern of movement; therefore, the pattern input can also be considered as “non-alphanumeric.” As also defined herein, a non-alphanumeric pattern of movement is an integrated or total motion over a time interval, which comprises at least one user motion that is other than the user directly typing an alphanumeric sequence into the user interface. Moreover, in this detailed description, the phrases “pattern of movement” and “non-alphanumeric pattern of movement” are used interchangeably, and the phrases “pattern input” and “non-alphanumeric pattern input” are used interchangeably.

By changing the direction or duration of the pattern of movement, the user generates a unique pattern input into the electronic device. This allows for changing a pattern input by altering the pattern of movement upon the user interface. A representation of a unique pattern input may then be stored as an unlocking pattern on the device and associated (e.g., via the storage mechanism such as by the use of a table or pointers) with a particular profile. In this way, the stored unlocking pattern for the profile allows the profile to be loaded any time a user executes the corresponding pattern of movement upon the user interface and, thereby, generates a pattern input that “matches” the stored unlocking pattern. Thus, in accordance with the present teaching, each stored profile and associated stored unlocking pattern corresponds to at least one different non-alphanumeric pattern of movement.

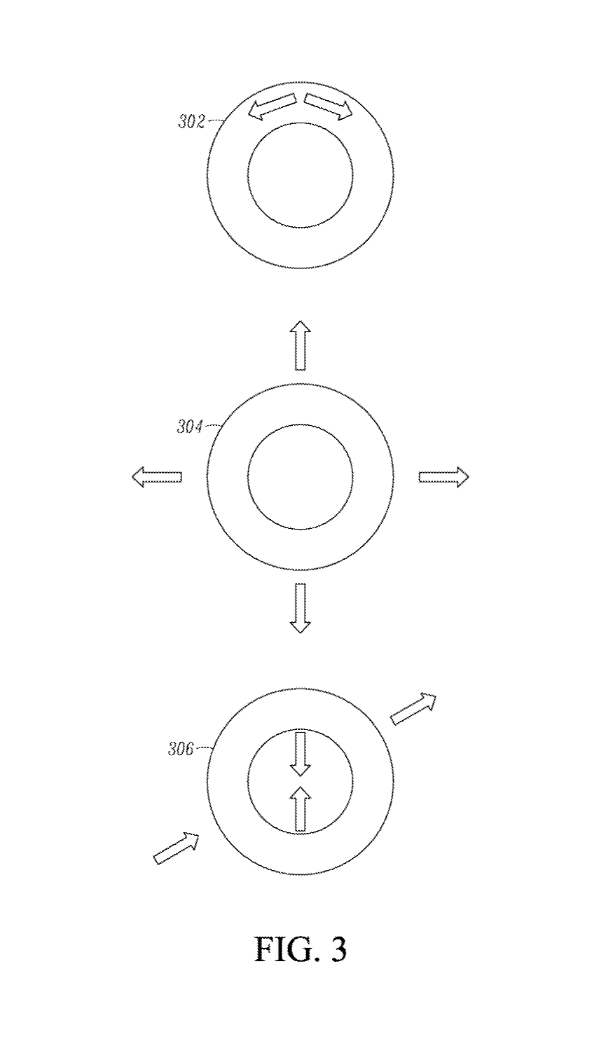

Turning back momentarily to the electronic device shown in FIG. 1, the user interface comprises a touch screen 102, and the pattern input comprises a tracing pattern generated from the motion upon the touch screen 102. By dragging one or more fingers (e.g., a thumb and/or pointer finger) or stylus upon the touch screen 102 (also commonly known as using gestures or swipes), a user generates a tracing pattern, which serves as a pattern input for the touch screen 102. The tracing pattern becomes a locus (i.e., collection) of multiple contact points defined by a path taken by the user's finger(s) or stylus as it/they move over the touch screen 102. As such, it can be said that the pattern input is generated from a tracing of a locus of points upon a touch screen 102 of the electronic device. Examples of tracing patterns are provided below by reference to FIGS. 3-6. The touch screen 102 also doubles as a display, which in FIG. 1 functions as an unlocking screen showing an unlocking icon at 104. The unlocking icon at 104, in this case a rotary wheel, alerts the user that the device is locked and prepared to receive a pattern input. Accordingly, in this embodiment, the user interface for the device, namely the touch screen 102, is adapted to receive rotary tactile input.

When a user is ready to gain access to operate the electronic device with a specific profile (referred to herein as the first profile), the user generates the pattern input associated with the first profile by reproducing the correct pattern of movement upon the user interface. The device receives the pattern input at 204, whereupon a processing element determines (206) if the entered pattern input matches the unlocking pattern of a stored profile. If the entered pattern input matches one of the stored unlocking patterns, the device proceeds to perform an unlocking procedure (represented by 208-218), which unlocks the device and loads the corresponding profile (which in this case is the first profile). Otherwise, the process returns to block 204 until the device receives another pattern input.

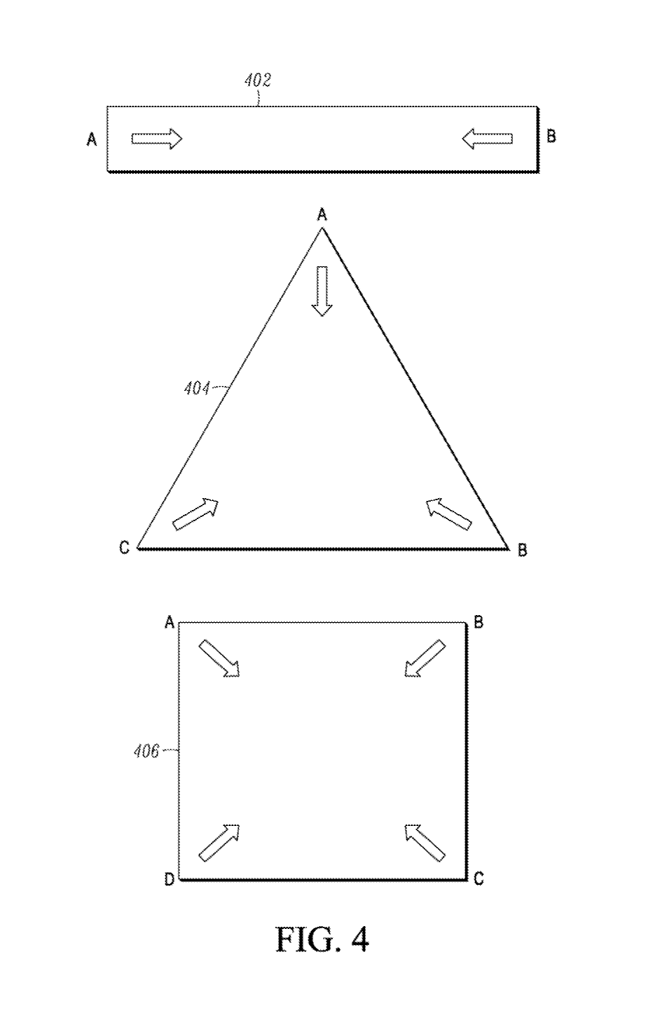

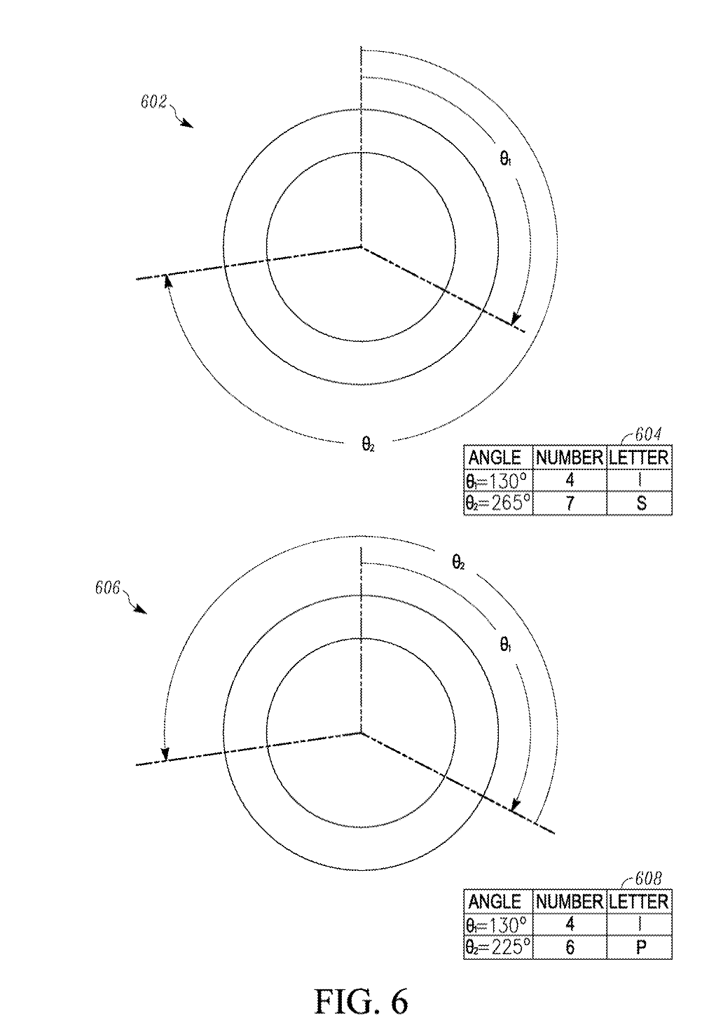

The unlocking procedure begins with the device determining at 208 whether a supplemental authentication procedure is required for the first profile. The supplemental authentication procedure is an additional security measure used to verify the identity of the user trying to gain access to the device and the first profile.

Where no supplemental authentication is required, the unlocking procedure comprises unlocking (216) the device, so that the user now has access to operate the device, and loading (218) the first profile. Loading a profile, as used herein, means taking a profile from the memory of a device and making it available for use. In an embodiment where no supplemental authentication is required, the pattern input also functions as an authentication code to authenticate the user. For example, a sequence of movements (i.e., a tracing pattern) that generates a particular pattern input further correlates to a sequence of alphanumeric digits that comprise a particular authentication code, for instance as described below by reference to FIG. 6. Alternatively, each pattern input comprises a sequence of motions, wherein the sequence of motions in itself is unique enough to authenticate (i.e., identify) a particular user. Any of the tracing patterns described with respect to FIG. 5, for example, can serve a dual role of user authentication and unlocking the device. In another embodiment, no user authentication is implemented at all. The pattern input or pattern of movement (and resulting tracing pattern) is simple and serves only to identify the profile that is to be loaded. Such simple tracing patterns, which are generally the least secure, are described below by reference to FIGS. 3 and 4.

Where the unlocking procedure requires the user to complete a supplemental authentication procedure prior to unlocking the device and loading a specific profile, the user is prompted (210) for authentication input. Such a prompting comprises providing a screen for receiving a passcode, in one embodiment. In another embodiment, the prompting comprises providing an unlocking icon, such as the icon 104 or a comparable icon, for receiving a pattern input. Accordingly, for at least some embodiments, completing the supplemental authentication procedure comprises the device receiving a second pattern input generated from motion upon the user interface of the electronic device or receiving a passcode, wherein the second pattern input and the passcode each serve as a supplemental input.

More particularly, in one embodiment, the supplemental input that serves to authenticate the user is simply a passcode, which is defined herein as a sequence of alphanumeric characters entered into the device. Examples of passcodes include, but are not limited to, a password, pin, passphrase, etc. In alternate embodiments, however, the supplemental input is a pattern input generated from motion upon a touch screen or a mechanical user interface. In one such embodiment, this supplemental pattern input comprises a sequence of motions that correlates to a passcode, as shown by reference to FIG. 5 and FIG. 6. However, regardless if whether or not there is a correlation to alphanumeric characters, the uniqueness of the sequence of motions, such as is described by reference to FIG. 5 and FIG. 6, can serve to authenticate the user.

At 212, the device receives the authentication input entered by the user. After the device authenticates (214) the user, it unlocks the device and loads the specific profile as indicated above at 216 and 218, thus completing the unlocking procedure. In an embodiment, authenticating the user comprises checking the authentication input against a stored authentication code or pattern for the user (e.g., a stored passcode or a stored pattern) for a match.

FIG. 3 is schematic diagram illustrating the function of an unlocking icon for a touch screen adapted to receive rotary tactile input consistent with an embodiment of the present teachings. Rotary tactile input occurs where the tracing pattern generated from the motion upon the touch screen comprises at least one arc length. An arc length, also referred to herein as an arc portion, is a piece of the tracing pattern that defines a curve, a curve being defined as a smooth line comprising points that are not collinear (i.e., a line that deviates from straightness in a smooth, continuous fashion). Examples of arc lengths include portions of the circumference of a circle or ellipse.

Specifically, FIG. 3 shows a rotary wheel configured for three different types of pattern input. Generating tracing patterns comprising arc portions using the rotary wheel is demonstrated at 302. A finger or stylus is placed upon the rotary wheel at the twelve-o'clock position and dragged clockwise in a circular arc to generate a tracing pattern as indicated by the right-hand arrow. The motion may stop at the six-o'clock position, or continue full circle. A second tracing pattern is generated by dragging a finger counterclockwise from the twelve-o'clock position as indicated by the left-hand arrow. In a similar fashion, two more tracing patterns are generated by dragging a finger upward from the six-o'clock position in either the clockwise or counterclockwise direction. Each tracing pattern so generated represents a different unlocking pattern.

The rotary wheel as displayed at 304 demonstrates how the unlocking icon is used when the touch screen is also adapted to receive linear tactile input. Linear tactile input occurs where the tracing pattern generated from the motion upon the touch screen comprises at least one line segment. A line segment, also referred to herein as a line portion, is a portion of a line that is bounded by two end points and contains every point on the line between those two end points. Using the rotary wheel to generate four different tracing patterns comprising line portions is accomplished by placing a finger anywhere on the rotary wheel and dragging it either up, down, right, or left as indicated by the arrows at 304. In an alternate embodiment, the translational motion in any direction begins with a finger placed between the concentric circles. By dragging the finger either inward, through the center of the wheel, or outward, away from the circumference of the inner circle, two different tracing patterns can be generated for each arrow shown at 304.

Using the rotary wheel to generate tracing patterns from the simultaneous motion of two contact points is demonstrated at 306. By using the movement of the thumb and finger together, the rotary wheel is pinched or expanded, generating two different locking patterns, as indicated at 306 by the inward-facing and outward-facing arrows, respectively. In accordance with the present disclosure, a touch screen is adapted to accept various types of pattern input, thus increasing the number of stored profiles that can be associated with an unlocking pattern. For example, the pattern inputs described below by reference to FIG. 4 are derived from a user dragging a finger or stylus from a vertex toward the center of an unlocking icon. However, another set of pattern inputs is realized by a user swiping outward from the center of the unlocking icons toward one or more vertices. Accordingly, the tracing patterns described herein by reference to FIGS. 3-6 represent only a small sample of tracing patterns that can be generated.

FIG. 4 is schematic diagram illustrating the function of different unlocking icons displayed on a touch screen consistent with another embodiment of the present teachings. Specifically, FIG. 4 shows three geometric figures with increasing numbers of vertices: a bar 402, a triangle 404, and a square 406. In an embodiment, each geometric figure serves as the unlocking icon displayed by the touch screen of an electronic device depending on how many profiles are stored on the device. Intelligence possessed by the device, supplied by its processing element running an algorithm, for example, allows the device to determine the number of stored profiles at any given time. In an alternative embodiment, the device displays only one such icon irrespective of the number of profiles stored.

In the above-mentioned illustrative embodiment, the device automatically displays the geometric figure that has the same number of vertices as stored profiles. If, for example, the plurality of stored profiles comprises two profiles, the device shows the unlocking icon represented by the bar at 402. By placing a finger at position A and swiping toward position B, a first profile is loaded as the device is unlocked. Swiping in the opposite direction, from B toward A, loads the second of the two stored profiles. Where the device holds three stored profiles, the user sees the triangular unlocking icon shown at 404. The user places a finger on the corner of the figure associated with the desired profile and traces along an imaginary line connecting the corner to the center of the figure as indicated by the arrows at 404.

The device automatically displays the square 406 when a user has four profiles to choose from. Again, the device selects the profile in response to a user dragging a finger from a corner of the square toward its center, thereby generating a tracing pattern which begins at the appropriate corner of the square and stops where the finger is lifted. Choosing which corners to link with which profiles is done at the time new profiles are stored. By programming in this way, for example, a user directs the device to associate vertex A of icon 404 (and its associated tracing pattern) with a work profile and vertex B (and its associated tracing pattern) with a personal profile, while allowing vertex C (and its associated tracing pattern) to be used for the profile of a family member.

FIG. 5 is a schematic diagram of unlocking icons displayed on a touch screen that allow for the generation of tracing patterns that are more complex than those indicated above by reference to FIGS. 3 and 4. Adding complexity to the tracing pattern can increase security by making the tracing pattern more difficult to guess or reproduce through trial and error. In a particular embodiment, tracing patterns generated with the unlocking icons shown in FIG. 5 also correlate to passcodes. However, such a correlation is not a requirement of this embodiment. In accordance with this embodiment, unlocking icons shown at 502, 504, and 506 are subdivided into multiple regions. A rotary unlocking wheel at 502, for example, is subdivided into four regions, indicated by the numerals “1-4,” but for the embodiments illustrated at 506 and 506, the unlocking icons are subdivided into differing numbers of regions.

Turning back to the unlocking wheel at 502, a user generates tracing patterns upon the unlocking wheel 502 by tracing paths that begin, end, and pivot at the various indicated regions. For example, one unlocking pattern involves the user placing a finger at “1,” dragging the finger clockwise past “2” and “3” to “4,” pivoting at “4” and dragging the finger counter-clockwise past “3” to “2,” and finally, pivoting on “2” and dragging the finger clockwise to “3.” For simplicity and clarity of description, input patterns are indicated herein by a sequence of numbers (i.e., identifying regions), all but the last of which is followed by a direction. However, the input patterns may (but need not necessarily) correlate to a passcode comprising the sequence of numbers, e.g., for purposes of authentication. Moreover, the regions could have just as easily been identified using letters or other characters, such as an asterisk, dot, etc., which may or may not be displayed to the user on the touch screen.

The first and last numbers of the input pattern traced on the wheel 502, represent the respective start- and endpoint of the pattern, while the numbers in-between indicate pivot points. Using this convention, additional tracing patterns generated upon the wheel 502 include 3-clockwise-1-counterclockwise-4-clockwise-2 and 1-counterclockwise-1-clockwise-2. While the latter of these two examples comprises an arc portion that is a full 360 degrees, patterns with arc portions that exceed 360 degrees may also be generated.

The unlocking icon shown at 504 is a bar that has been divided into three regions. While using a larger number of regions is again possible, creating more regions on which to pivot requires more sensitivity from the touch screen and greater precision from the user when inputting a tracing pattern. Examples of tracing patterns generated by using the bar include 3-left-1-right-2-left-1 and 1-right-2-left-1-right 3.

The third unlocking icon 506 shown in FIG. 5 combines elements of the previous two unlocking icons, wherein the tracing pattern (i.e., tracing) comprises at least one of an arc portion or a line portion. The unlocking icon 506 comprises a wheel portion and two bar portions and is subdivided into 5 regions. From any of the indicated regions on the wheel portion of the unlocking icon 506, tracing can proceed inward toward region 5 along one of the two bar portions, or continue on the wheel portion. Examples of tracing patterns generated from the unlocking icon at 506 include 3-counterclockwise-2-left-5-up-1-counterclockwise-3 and 1-clockwise-4-right-2-counterclockwise-4. Each of these tracing patterns (i.e., tracings) comprises at least one line segment, but other patterns might comprise only arc lengths. Likewise, each of the tracing patterns also contains at least one arc length but need not comprise any.

One way to increase complexity for tracing patterns generated with unlocking icons 502-506 is to increase the number of pivot points in a sequence. Alternatively, two consecutive tracing patterns may be input where performing the unlocking procedure further comprises completing a supplemental authentication procedure prior to unlocking the device and loading the first profile. The first tracing pattern serves to identify a specific profile belonging to a specific user that is to be loaded, after which the second tracing pattern is used as user authentication prior to unlocking the device. When using the rotary wheel unlocking icon, any of the tracing patterns indicated above by reference to FIG. 3 might serve as the first tracing pattern used to identify a particular profile, while any of the tracing patterns indicated for the wheel at 502 or the unlocking icons at 504 and 506 might serve as the second tracing pattern for completing the supplemental authentication procedure. In a further embodiment, a tracing pattern generated using the unlocking icon 502, 504, or 506 can be used as the sole pattern input to unlock the device, authenticate the user and load the desired profile, without the use of a supplemental input.

FIG. 6 illustrates an alternate way the rotary wheel unlocking icon is used to generate tracing patterns. In particular, the tracing patterns (i.e., tracings) comprise sequences of arc lengths (i.e., arc portions) that correlate to alphanumeric sequences used to authenticate a user of the electronic device. This is done by subdividing the wheel into regions based on angle measures, and then assigning one or more symbols to each region. By ending or pivoting the tracing motion on particular regions, a string of symbols is built up which correlates to a particular passcode.

The wheel shown at 602 illustrates building up a passcode from tracing individual arc lengths that all begin from the same point (the twelve-o'clock position, which corresponds to an angle measure of zero). For ease of illustration, symbols are limited to the first 10 counting numbers and the 26 letters of the alphabet, with the understanding that an actual commercial embodiment is not so limited. The regions are defined for the numbers and letters by dividing the wheel circumference-wise into 10 and 26 arc sections, respectively.

Focusing first on the numbers, each digit is represented by 36 degrees of arc. Ten such arc sections combine to make up the full 360 degrees of the wheel's circumference. The first 36 degree arc section corresponds to the digit “0” and is centered at the 12-o'clock position which represents zero degrees. The region corresponding to the digit “0” thus begins at −18 (or 342) degrees and extends to +18 degrees. The region representing “1” is the next 36 degree arc section, extending from 18 to 54 degrees. The arc sections are so continued until the last one, representing the digit “9,” completes the circle by beginning at 306 degrees and ending at 342 degrees. In a similar fashion, the wheel is also subdivided into 26 arc sections, each slightly less than 14 degrees, to create a region for every letter in the alphabet. Generally, the beginning and ending angle measure of the i^{th} of n arc sections is:

$$( i - 1 ) \frac{360}{n} \pm \frac{360}{2 n} .$$

As shown at 602, a user begins to generate a pattern input that correlates to a passcode by placing a finger at zero degrees and tracing out an arc length in the clockwise direction until the finger falls within the region that correlates to the first character of the passcode. As the finger is dragged through successive regions, the screen on the device displays characters in real time as the regions are traversed. When the screen displays the correct character, the user lifts his finger, which sets the first character of the passcode. At 602, the first arc length traced ends at an angle measure of 130 degrees, which falls within the number region that correlates to the number “4”) (126°-162° and the letter region that correlates to the letter “I”) (118°-132°, as shown by the table at 604. In an alternate embodiment, the number regions are centered about the positions the numbers take on the face of an analog clock.

The second traced arc length at 602 illustrates the user's motion upon the touch screen which correlates to the second character of the passcode. The user again begins by placing a finger at zero degrees and dragging out an arc length in the clockwise direction until the screen displays the second character of the passcode, after which the finger is removed; the second character is set; and the process repeats for any remaining passocde characters. As shown at 604, the angle measure of 265 degrees for the second traced arc length correlates to both the number “7” and the letter “S.” Thus, in this case, the sequences 4-7, I-S, 4-S, and 1-7 all correspond to the same traced pattern which comprises two arc lengths. Accordingly, in an embodiment, the device includes a suitable algorithm to determine, from the tracing pattern, the correct sequence of alphanumeric characters to use in authenticating the user. For longer passcodes, the tracing pattern comprises more arc lengths.

The rotary wheel shown at 606 illustrates how a continuous tracing pattern correlates to a passcode, while eliminating the need to reposition the contact point with the touch screen between characters. The first 130 degree arc length of the tracing pattern, and thus the first character of the passcode, is input as before. The second arc length, however, begins where the first one ends, at 130 degrees. Characters are set not only when a finger is lifted from the touch screen (at the last region), but also when the trace reverses direction (at the pivot regions). As the user begins to trace the second arc length in the opposite (counterclockwise) direction without lifting his finger, the device sets the first character to “4” or “I” and “zeros out” the displayed character showing on the screen to “0” or “A.” As the second arc length is traced, the displayed character is incremented with the motion until the user either again reverses direction or breaks contact with the screen, which signals completion of the passcode. As shown at 608, the second arc length at 606 measures 225 degrees and corresponds to the number “6” or the letter “P.”

Tracing patterns that correlate to passcodes, as described above by reference to FIG. 6, are used in one embodiment to unlock the device, authenticate the user, and load a corresponding profile, without using a supplemental input. A user simply enters the tracing pattern that correlates to a passcode “3758,” for example, whereupon the device is unlocked and made available for use with the proper profile. In an alternative embodiment, a tracing pattern given by reference to FIG. 6 is used as a supplemental input during a supplemental authentication procedure performed prior to unlocking the device and loading the profile. A user begins by tracing an arc portion on the rotary unlocking icon in the clockwise direction as described above by reference to FIG. 3 at 302, indicating he wishes access to his work profile. The device responds by prompting the user for authentication input as indicated above by reference to FIG. 2 at 210. The user now enters a tracing pattern that correlates to the passcode “3758,” for example, and the device unlocks and the correct work profile is loaded. In one alternative embodiment, the user utilizes the same tracing pattern, correlating to a single passcode, to authenticate each of his profiles. In another alternative embodiment, a different tracing pattern is used for the authentication of each profile.

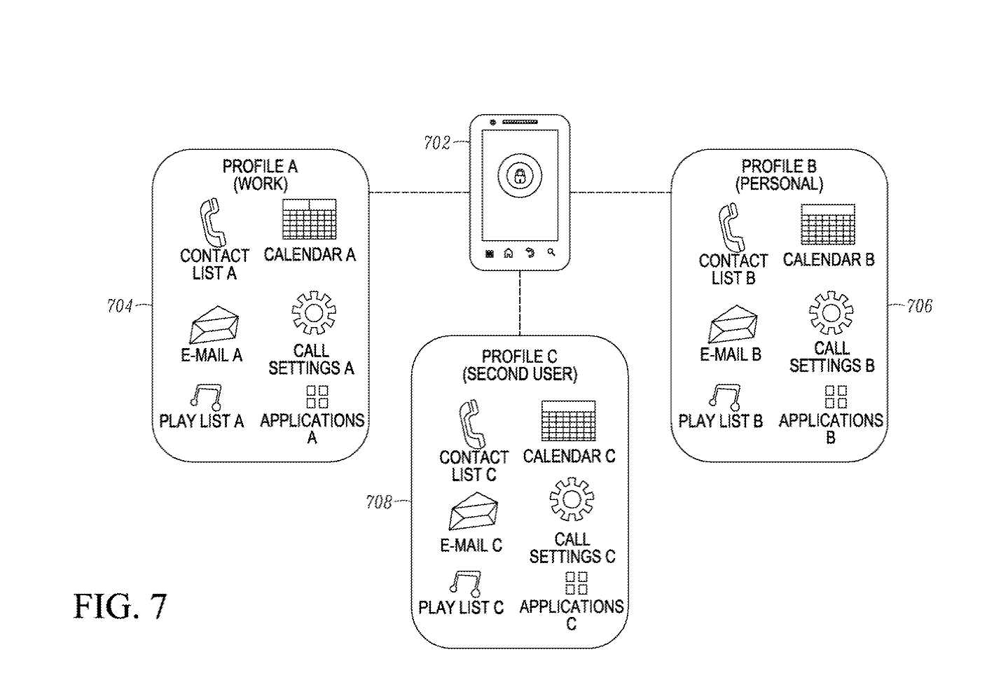

FIG. 7 is a schematic diagram illustrating the properties of and differences between profiles stored on an electronic device consistent with an embodiment of the present disclosure. In particular, FIG. 7 shows a plurality of profiles (in this case three profiles 704, 706, and 708) stored on a cellular telephone 702, wherein at least two profiles of the plurality of profiles, namely profile A 704 and profile B 706, are associated with the same user, and wherein at least two profiles of the plurality of profiles, e.g., B 706 and C 708, are associated with different users. A stored profile for either a primary or secondary user of a phone can be simple, comprising as few as one or two customized settings, such as a chosen ringtone and/or a personalized background, or it can be “feature rich” and allow for expansive customization by the user. Each of the profiles shown in FIG. 7 at A 704 through C 708 includes a corresponding contact list, calendar, e-mail, call settings, play list, and applications. The user has the ability to adjust functionality with regard to any of these features, or to apply further customization with regard to features not explicitly shown.

For an embodiment of the work profile shown at 704, contact list A is set so that only work contacts are displayed when the work profile A704 is loaded on the cellular telephone 702. A user wishing to include certain personal contacts on the work contact list marks those contacts as being both work and personal contacts so they display when either the work profile A 704 or the personal profile B 706 is loaded on the cellular telephone 702. Similarly, calendar A is set up so that only work-related calendar items are displayed, leaving non-work-related items for another calendar. From within the work profile A 704, the user chooses to see additional calendar items by toggling between calendars, or using a function to “overlay” multiple calendars. Before scheduling a late meeting at the office, for example, a user might want to check his social calendar for conflicts by using either the toggle or overlay feature.

In another embodiment, by implementing optional call settings, the functionality of contact list A and calendar A at 704 are integrated. How to handle an incoming call received by a phone running a work profile A 704, for instance, is specified in call settings A. Upon receiving the incoming call, the phone 702 references calendar A to determine if the user is in a meeting. The call is immediately directed to voicemail (i.e., silent mode) during a meeting, or allowed to ring through when no meeting is taking place. Under a different setting, calls from numbers not on contact list A are directed to voicemail, while an optional override feature prevents calls of an emergency nature from being screened when a “911” sequence is entered, for example. By adjusting call settings A, a user selects a special ring tone for incoming calls that are placed by contacts appearing on contact list A. Calls not matching a contact on the list ring differently, thereby allowing the user to selectively ignore calls without having to check a caller ID. Where a user fails to answer, the phone 702 plays different greetings depending on whether or not the caller appears on contact list A.

E-mail settings under the work profile shown at 704 are also customized A dedicated work e-mail account, for example, is prioritized over other e-mail accounts. Listings and new e-mail notifications from other accounts are suspended while profile A is loaded. Likewise, other applications are selectively loaded or displayed. Work-related applications are made available for use while games and other social applications are automatically switched off. This increases efficiency by eliminating clutter and freeing up memory on the phone 702. Alternatively, different types of applications are displayed using different trays or panels, making the most-frequently used applications the most accessible.

When the user of profile A 704 chooses instead to unlock the device using a pattern input that corresponds to profile B 706, personal settings the user has programmed are loaded and, thereby, take precedence over work settings. Contact list B is populated with social contacts, a personal e-mail account is prioritized over the work e-mail account, and calendar B displays personal dates and reminders instead of work-related ones. In a particular embodiment, calendar B also displays work-related calendar items. However, work-related items are programmed to appear below social entries or are shaded differently to make them easily differentiable.

Where the phone 702 has an integrated media player, play list B contains the user's preferred songs or audio books. A popular movie serves as a theme behind a personal ringtone and background, replacing the more formal settings of the work profile 704. Applications B exclude work-only applications in favor of games and social media, such as Facebook and Twitter, for example.

Where the phone 702 is used by a second user, such as a spouse or family member, the second user can also personalize the phone 702 by creating a stored profile. This allows the primary user, for example, to make some or all information from profiles A 704 and B 706 inaccessible to a second user. As indicated at 708, the present teachings address this implementation scenario by allowing for the creation of the third profile C, which is programmed to reflect the second user's personal preferences. A fourth profile (not shown) can be one that blocks all but the most rudimentary functions of the phone 702. Before handing the phone 702 over to a stranger to make a call, for example, the correct pattern input is used to unlock the phone 702 and load the fourth profile to allow the stranger to place a call without having access to any personal or work information (e.g., in profile 704, 706, and 708) stored on the phone 702. This is especially important where newer phones contain financial information and run programs with the ability to make virtual payments.

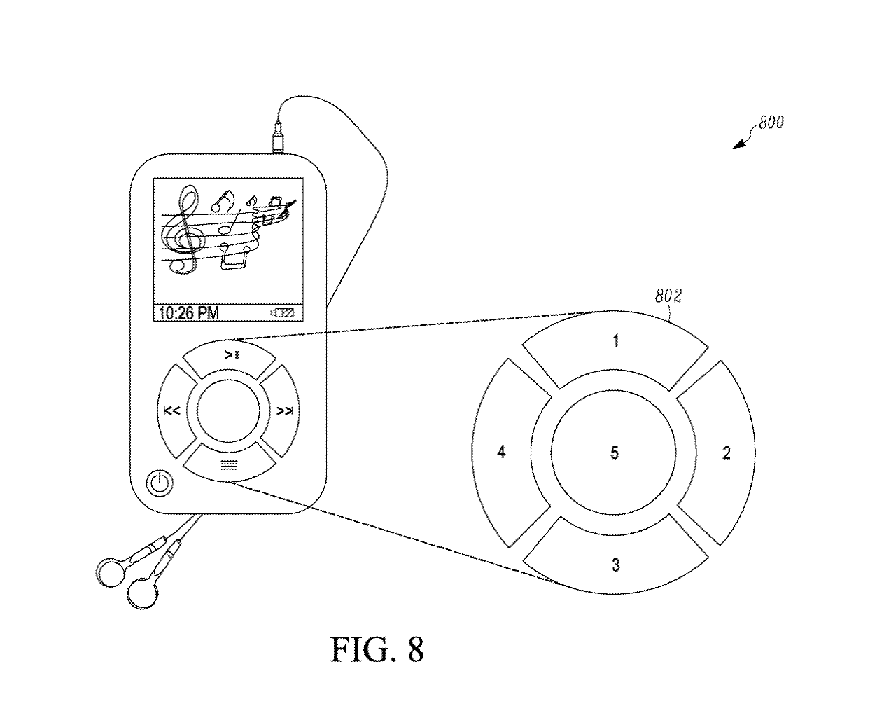

FIG. 8 shows an electronic device, wherein the user interface comprises a mechanical interface consistent with an embodiment of the present teachings. As used herein, a mechanical interface 802 of a device 800 is an interface through which the device 800 receives input by registering the physical movement of at least a part of that interface. A radio dial, for example, is a mechanical interface because the dial must be physically turned before input may be received by the radio. By contrast, the touch screen of a cellular phone is not a mechanical interface because no part of the touch screen must move in order for the phone to receive input.

More particularly, FIG. 8 shows a media player 800 with a mechanical interface 802 comprising five buttons. During normal operation, these buttons correspond to (clockwise from the top) the play/pause, fast forward/next track, menu, rewind/last track, and select functions. In accordance with the present teachings, the buttons 802 are also used to generate a pattern input, whereby a user unlocks the player 800 and loads one of a plurality of stored profiles. Individual profiles comprise play lists and other user-settable preferences, such as display color, shuffle play, 12/24-hour time format, equalizer setting, and visualizations, for example.

Pattern input is generated from the motion upon the mechanical user interface for this electronic device 800 by depressing its buttons 802 in a particular order. To simplify notation, the buttons have been labeled with the numbers “1” through “5” at 802. The sequence 3-2-5-1-4-3 generates a pattern input analogous to the first example of a tracing pattern given for the unlocking icon at 506 in FIG. 5. As an additional example, the sequence 1-5-3-4-5-2 represents a pattern input that resembles a cross. In a further embodiment, the pattern input also correlates to a passcode to authenticate the user.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” or “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially,” “essentially,” “approximately,” “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., a device comprising a processor or processing element, such as an electronic device in accordance with the present disclosure) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method for unlocking an electronic device that allows for profile selection, the method comprising:
storing a plurality of profiles, each associated with a different unlocking pattern;
receiving a first pattern input generated from motion upon a user interface of the electronic device; and
determining that the first pattern input matches an unlocking pattern associated with a first profile of the plurality of profiles and performing an unlocking procedure.

2. The method of claim 1, wherein the user interface comprises a touch screen and the first pattern input comprises a first tracing pattern generated from the motion upon the touch screen.

3. The method of claim 2, wherein the first tracing pattern comprises at least one arc length.

4. The method of claim 3, wherein the first tracing pattern comprises a sequence of arc lengths that correlates to an alphanumeric sequence used to authenticate a user of the electronic device.

5. The method of claim 2, wherein the first tracing pattern comprises at least one line segment.

6. The method of claim 1, wherein at least two profiles of the plurality of profiles are associated with different users.

7. The method of claim 1, wherein at least two profiles of the plurality of profiles are associated with a same user.

8. The method of claim 1, wherein performing the unlocking procedure comprises unlocking the device and loading the first profile.

9. The method of claim 8, wherein performing the unlocking procedure further comprises completing a supplemental authentication procedure prior to unlocking the device and loading the first profile.

10. The method of claim 9, wherein completing the supplemental authentication procedure comprises receiving a second pattern input generated from motion upon the user interface of the electronic device or receiving a passcode.

11. The method of claim 1, wherein the first pattern input is generated from motion upon a mechanical user interface of the electronic device.

12. An electronic device comprising:
a user interface adapted to receive tactile input;
a memory adapted to store a plurality of profiles each associated with a different pattern of movement used to provide access to operate the electronic device; and
a processing element adapted to:
detect a first pattern of movement from the tactile input;
determine that the first pattern of movement is associated with a first profile of the plurality of profiles; and
allow access to operate the device and responsively load the first profile.

13. The electronic device of claim 12, wherein the user interface comprises a mechanical interface.

14. The electronic device of claim 12, wherein the user interface comprises a touch screen.

15. The electronic device of claim 14, wherein the touch screen is adapted to receive rotary tactile input.

16. The electronic device of claim 14, wherein the touch screen is adapted to receive linear tactile input.

17. A non-transient computer-readable storage element having computer-readable code stored thereon for programming a computer to perform a method for unlocking an electronic device that allows for profile selection, the method comprising:
receiving user input for storing a plurality of profiles, each associated with a different unlocking pattern, wherein each stored profile and associated stored unlocking pattern corresponds to at least one different non-alphanumeric pattern of movement;
receiving a first pattern input generated from non-alphanumeric motion upon a user interface of the electronic device; and
determining that the first pattern input matches an unlocking pattern associated with a first profile of the plurality of profiles and performing an unlocking procedure.

18. The non-transient computer-readable storage element of claim 17, wherein the first pattern input is generated from a tracing of a locus of points upon a touch screen of the electronic device.

19. The non-transient computer-readable storage element of claim 18, wherein the tracing comprises at least one of:
an arc portion; or
a line portion.

20. The non-transient computer-readable storage element of claim 19, wherein the tracing comprises a sequence of arc portions that correlates to an alphanumeric sequence used to authenticate a user of the electronic device.
